(19) United States
(12) Patent Application Publication
(10) Pub. No.: US 2016/0087949 A1
(43) Pub. Date: Mar. 24, 2016

(54) ESTABLISHING SECURE DIGITAL RELATIONSHIP USING SYMBOLOGY

(71) Applicant: Intel Corporation, Santa Clara, CA (US)

(72) Inventors: William C. Deleeuw, Beaverton, OR (US); Ned M. Smith, Beaverton, OR (US)

(21) Appl. No.: 14/494,802

(22) Filed: Sep. 24, 2014

(51) Int. Cl. H04L 29/06

(52) U.S. Cl. CPC H04L 63/061; H04L 63/0876

(57) ABSTRACT

An embodiment includes an apparatus comprising: a display module; at least one memory coupled to the display module; at least one processor, coupled to the at least one memory, to perform operations comprising: (a) encoding first content, which is based on a first value, in a first bar code, (b) displaying the first bar code with the display module; (c) receiving a second bar code, which includes second content based on a second value, from a second computing node; (d) encoding third content, which is based on a third value, in a third bar code, (e) displaying the third bar code with the display module; (f) determining an encryption key based on the first and second values; and (g) exchanging a message, encrypted based on the encryption key, with the second computing node. Other embodiments are described herein.

### TECHNICAL FIELD

An embodiment addresses establishing a secure relationship between two computing nodes using symbology (e.g., bar codes such as quick response (QR) codes).

### BACKGROUND

Secure and private communication using email, instant messaging (IM), chat, short message service (SMS), multimedia messaging service (MMS), voice-over-internet protocol (VOIP), file transfer protocol (FTP) and the like may depend on the computing node end points having previously negotiated session keys. To obtain these previously negotiated session keys the computing nodes may have need to rely on trusted third party structures or organizations (e.g., Kerberos computer network authentication protocol, a certificate authority (CA), trusted couriers). Other approaches to obtain the previously negotiated keys include, for example, pretty good privacy (PGP) protocols and in-person “key parties” where keys may between users using a local area network (LAN), thumb-drives, and the like.

A security challenge facing third party key exchange is establishing initial trust in the third party and then maintaining clarity over what the third party can and cannot vouch for regarding key exchange participants. For example, Kerberos assumes all users are members of a Kerberos “realm”, which is centrally managed. Of course, this may not be the case between one or more parties interested in establishing secure digital relationships with each other. As another example, a corporate information technology (IT) organization may manage the user community composed of employees of the same organization. However, many parties interested in establishing secure digital relationships with each other may not belong to the same company or organization or have the resources to enlist help from such an IT organization.

Regarding one more example, CAs may manage large user communities but in so doing the CAs may restrict the richness of assertions about the user. For example, a Verisign® class 1 certificate may only vouch for the ability of an email address to result in someone willing to pay for the certificate issuance fees. Certificates are created and signed by CAs that vouch for the authenticity of the certificate. However, there are many CAs, many of whom may issue ill-advised certificates to parties that should not have such a certificate (e.g., users that attempt to obtain certificates for large organizations with which the users have no trust worthy relationship). Such a “bogus” certificate may allow an attacker to appear to be someone they are not (e.g., someone pretending to be a bank). In the end, some CA signatures only signify that someone paid the CA to issue and sign a certificate vouching for an identity. Thus, the use of CAs may not offer enough security for parties interested in establishing secure digital relationships with each other.

While there may be avenues for parties interested in establishing secure digital relationships to indeed establish those relationships to some degree, those avenues are often less than desirable because they rely on less than satisfactory secure channels (e.g., channels based on “trusted” third parties), and/or rely upon infrastructure and resources unavailable to many parties (e.g., environment managed by a corporate IT department), and/or overly burdensome to implement for all interested parties (e.g., key parties dependent on thumb drive exchanges).

### BRIEF DESCRIPTION OF THE DRAWINGS

Features and advantages of embodiments of the present invention will become apparent from the appended claims, the following detailed description of one or more example embodiments, and the corresponding figures, in which:

FIG. 1 includes computing nodes establishing a secure digital relationship using symbology (e.g., QR codes) in an embodiment of the invention.

FIG. 2 includes a process for computing nodes to establish a secure digital relationship using symbology in an embodiment of the invention.

FIG. 3 includes a process for computing nodes to establish a secure digital relationship using symbology in an embodiment of the invention.

FIG. 4 includes a system for use with an embodiment of the invention.

### DETAILED DESCRIPTION

In the following description, numerous specific details are set forth but embodiments of the invention may be practiced without these specific details. Well-known circuits, structures and techniques have not been shown in detail to avoid obscuring an understanding of this description. “An embodiment”, “various embodiments” and the like indicate embodiment(s) so described may include particular features, structures, or characteristics, but not every embodiment necessarily includes the particular features, structures, or characteristics. Some embodiments may have some, all, or none of the features described for other embodiments. “First”, “second”, “third” and the like describe a common object and indicate different instances of like objects are being referred to. Such adjectives do not imply objects so described must be in a given sequence, either temporally, spatially, in ranking, or in any other manner.

An embodiment of the invention addresses various challenges to establishing secure relationships between computing nodes. The embodiment does so by using QR codes and cameras on two computing nodes. More specifically, a series of QR codes are displayed on displays of the computing nodes (e.g., smartphones) in a sequence to support a key exchange protocol (e.g., Diffie-Hellman protocol, SIGn and MAc (Sigma) protocol). Such an embodiment provides a desirable user experience because, when users are in physical proximity to one another, they may point their respective phones at one another to perform the key exchange protocol. In some embodiments the key exchange protocol may occur between computing nodes that each utilize a Trusted Execution Environment (TEE) so additional trust can be established without the use of a trusted third party (e.g., trusted key server).

As a result, embodiments allow users (e.g., people, robots) who meet in physical proximity with one another occasionally (or frequently) to establish shared keys without a key server or any networking connectivity. For example, key exchange between two parties could occur on an airplane, subway, or other environment lacking connectivity (e.g., Wi-Fi, cellular) for whatever reason.

As a contextual note, many embodiments described herein concern QR codes. However, embodiments of the invention are not so limited and may rely on various forms of symbology to implement the key exchange protocol. For example, embodiments may generally concern a barcode. A barcode is a machine-readable representation of data relating to an object, product, and the like. A barcode can be found in a variety of different formats including one dimensional (1D), 2D, and 3D variations. Barcodes may be read by scanners that “read” small images of lines, bars and spaces and translate these symbols into data. Barcode symbology is the mapping between messages and barcodes. This includes the encoding of the characters and the bars/spaces that compose a barcode. Opposed to the singular 1D barcode, a 2D barcode exists on two physical planes and stores information both horizontally and vertically. 2D offers a far greater informational capacity than a 1D barcode. They enable fast data access. A QR Code is a 2D barcode consisting of black and white squares. QR Codes can store information, such as URLs or keys or values/messages, and can be read by a camera on a mobile phone. A 3D barcode provides a more permanent solution to barcoding than stickers/displays used for 1 and 2D barcodes. The barcodes are read by variances in the heights of bars. 3D barcodes may be created using 3D printers where information about the printed object may be encoded as part of the object and where a 3D QR reader device may easily scan the 3D bar code.

Due to the “payload capacity” of a QR code, various embodiments use QR images as a data transport channel that has sufficient bandwidth to perform security key exchange protocols such as Sigma based key exchange protocol (e.g., Intel® Identity Protection Technology (Intel® IPT)). Other protocols may be supported as well. Sigma protocols in particular are used in embodiments because they support digital relationship establishment with key exchange but do not require a trusted third party identity provider. As a result, embodiments support key exchange in unconnected situations or when services such as Bluetooth® are not available. Still, not all embodiments require the Sigma based key exchange protocol.

As briefly mentioned above, in some embodiments the key exchange protocol may occur between computing nodes that each utilize a TEE, which provides a trusted input/output (I/O) environment to perform attestable key exchange. When there is a trusted I/O capability between the TEE and camera/display the users also gain increased trust that exchanges are not monitored by malware on the devices and the users benefit from social trust that is intuitive for in-person meetings.

As an added benefit, the users engaging in QR code exchange in close proximity to one another (in some embodiments) provide a context of “social trust” based on for example, “social trust indicators”. Social trust indicators include things like, for example, (1) two parties having met and exchanged things in the past have an element of trust not shared by one of those parties with some anonymous party that he or she has never exchanges things with before; (2) the continuity of subject matter of messages between parties (e.g., Bob and Alice have a history of discussing baseball together so if Bob receives an email from Alice attempting to sell him a used car Bob may be suspicious as to whether Alice actually send the email; (3) consistency of messaging forms (e.g., Alice and Bob typically communicate by email so a text from Alice to Bob may be suspicious to Bob; (4) language used (e.g., Alice and Bob typically communicate in English so an email from Alice to Bob written in French may be suspicious to Bob; (5) communication patterns (e.g., Alice typically email Bob and addresses him as “Bob” so an email allegedly from Alice addressing Bob as “Robert” may be suspicious to Bob; (6) if Bob knows Alice and has some doubts about his communications with Alice, and Carl trusts Bob, then Bob's appraisal of Alice's authenticity is useful to Carl as well.

This “social trust” trust lingers and follows the resultant keys so subsequent use of the keys (e.g., to create other keys or communicate between parties years from the original exchange of keys) may refresh the user's memory regarding the social trust environment in which the key exchange originally occurred (e.g., remembering the person and the exchange when the key generation content was originally exchanged via QR codes). This provides important reminders to the users that may help the users make responsible subsequent security decisions. 3D printed artifacts containing 3D bar codes may exist as part of the contextual environment in which social trust is established and may be observed by a 3D bar code reader/camera.

Thus embodiments have many advantages. First, social trust indicators (addressed above) can be established and stored/remembered as context for negotiated keys. Second, strong, attestable, privacy preserving, confidential key exchange protocols are used (with or without trusted third party support). Third, convenient QR codes can be used to implement a data transport protocol to host security protocols. Fourth, key exchange can be performed with a device containing a camera, display, scanner, and software. Fifth, attestation of TEE software can be used to detect a compromised TEE (and hence the threat of a man-in-the-middle (MITM) attacker).

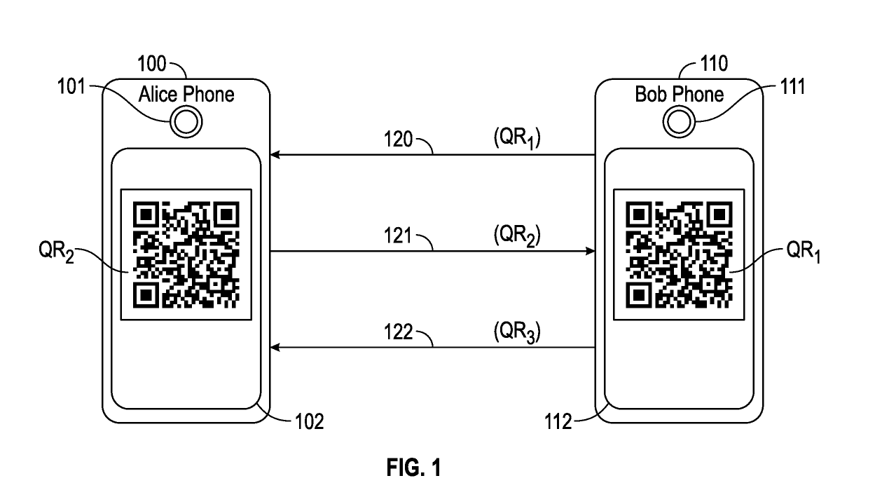

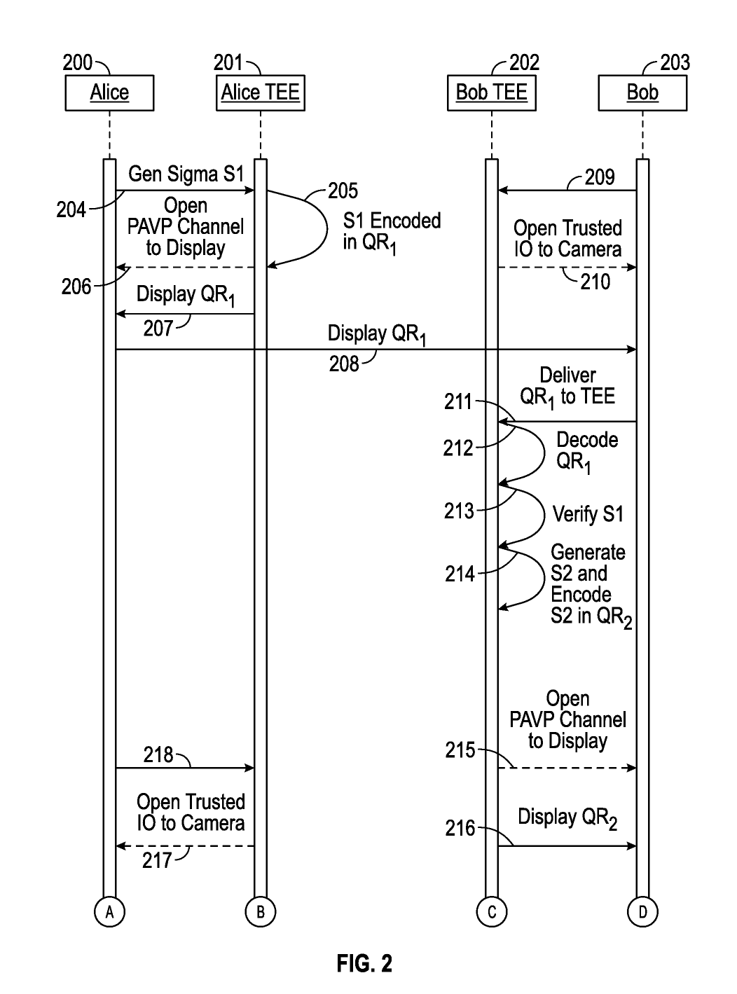

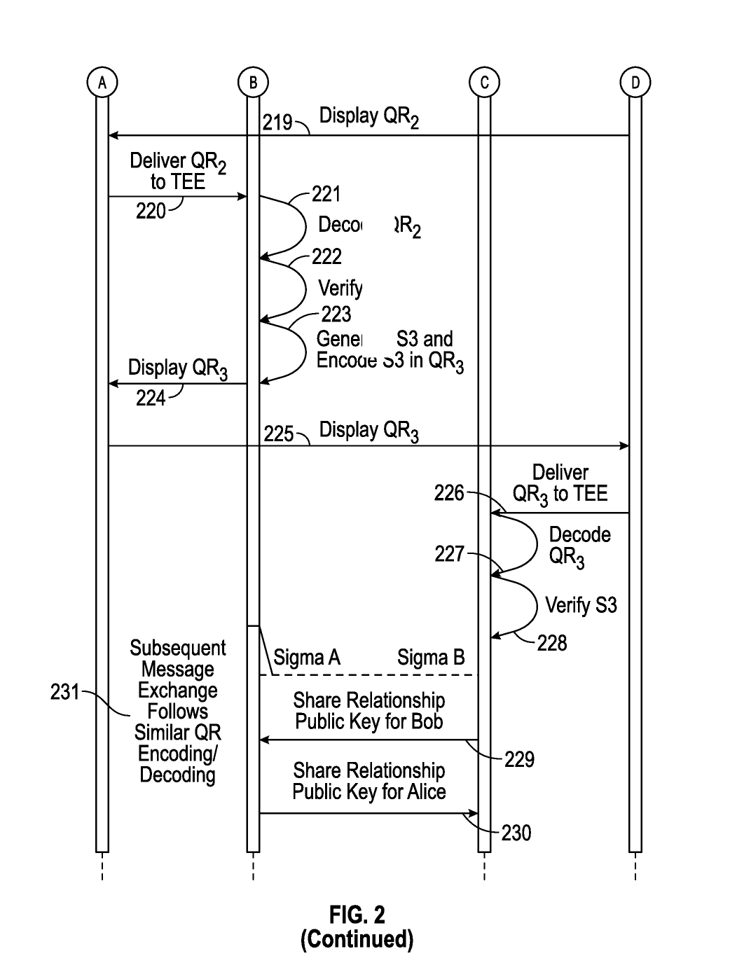

FIG. 1 includes computing nodes establishing a secure digital relationship using symbology in an embodiment of the invention. FIG. 1 shows an example user experience where computing nodes 100, 110 follow a protocol of sequenced QR code display and read operations that allows arbitrary data exchange. Computing nodes may include, for example, smartphones, tablets, PCs, mobile computing nodes, parts of distributed computing networks, netbooks, automobile dashboard displays, wearable computing nodes (e.g., spectacles with connectivity), and various computing components in the “Internet of Things” (interconnection of uniquely identifiable embedded computing-like devices within the existing Internet infrastructure such as “smart” thermostats and the like). QR codes implement protocol flow control as well as data payload and framing, which concerns a QR code “quiet zone” that is a blank margin on either side of a barcode that is used to tell a barcode reader where a barcode's symbology starts and ends. Camera 100 reads a protocol frame while display 112 sends/displays the frame. In other words, phone 110 displays a QR code on display 112 and camera 101 of phone 100 then scans or otherwise interprets the QR code. This is depicted generally by transfer 120 whereby information is encoded in a first QR code (QR1) and transferred from phone 110 to phone 100. In an embodiment camera 111 monitors display 102 for an acknowledgement (ACK) message indicating QR1 was received by node 101 and it is acceptable for the protocol to proceed. Next, phone 100 displays a second QR code (QR2) on display 102 and camera 111 of phone 110 scans or otherwise interprets the QR code. QR2 may be different than QR1 regardless of how the QRs are depicted in FIG. 1. This is depicted generally by transfer 121 whereby information is encoded in a second QR code (QR2) and transferred from phone 100 to phone 110. An ACK message may or may not be received by phone 100. Next, phone 110 displays a third QR code (QR3) (not shown) on display 112 and camera 101 of phone 100 scans or otherwise interprets the QR code. This is depicted generally by transfer 122 whereby information is encoded in a third QR code (QR3) and transferred from phone 110 to phone 100. An embodiment of this “three part” handshake is described in FIG. 2. While several embodiments discussed herein address a three part handshake, other variations (e.g., two part handshake, four part handshake, and the like) are also possible in other embodiments based on varying key exchange protocols.

If computing nodes 100, 110 support a TEE (e.g., Intel® Software Guard Extensions (Intel® SGX)), the sequence of operations of FIG. 2 may be performed to establish shared symmetric keys according to a Diffie-Hellman key exchange protocol. In an embodiment the sequence of operations of FIG. 2 may be performed to establish shared symmetric keys according to a Sigma key exchange protocol, which is an example of a signed Diffie-Hellman protocol that has privacy preserving properties. However, computing nodes lacking a TEE may still participate in other embodiments of the invention.

Regarding FIG. 2, the figure addresses an embodiment of a key exchange protocol that preserves “social trust” and does not require a trusted third party. The use of TEE environments 201, 202 by either or both of computing nodes 200, 203 is not mandatory. However, doing so establishes that the keys exchanged between nodes 200, 203 are protected by the TEE (i.e., safe from malware on each side that uses a TEE) and that the user(s) are physically present when the key exchange occurred. An example of a TEE includes a trusted I/O channel to the camera and display (e.g., Protected Audio Video Path (PAVP)). The assertion of user presence is further augmented by the phone's user authentication system asserting to the TEE which user is performing the key exchange operation. The TEE may include an attestation of the TEE environment to the remote party enabling a whitelist verification of the first TEE. Regarding the value of “user presence”, Alice trusts the key exchange with Bob because she was sitting next to Bob when she exchanged keys with Bob and therefore knows it was indeed Bob she was exchanging keys with and not someone just pretending to be Bob, which is easier to do using email, the internet, and the like. Regarding the value of using a TEE, the TEE allows one party to know the precise software code running on another system that was run to produce an answer. Bob can know, for example, that the key production software on Alice's phone is the same as the key production software on Bob's phone. This eliminates/reduces malware opportunities to pretend to be a key exchange application for the purposes of getting access to keys it should not have access to. For the embodiment of FIG. 2 there is no assumption of a trusted third party acting as a naming authority that both “Alice” (the user of node 200) and “Bob” (the user of node 203) subscribe to.

At element 204 node 200 generates Sigma content (S1). This content may include g^{x}, based on the value x, of a typical Diffie-Hellman/Sigma process. The S1 content need not include g^{x} in all embodiments or only include g^{x} in all embodiments. The Diffie-Hellman and Sigma protocols are known to those of ordinary skill in cryptography and are not discussed in detail herein. An example of a Sigma protocol is available in the following book: Host Identity Protocol (HIP): Towards the Secure Mobile Internet, by Andrei Gurtov, July 2008 (pp. 35-37). S1 may be generated in node 200 or within TEE 201. S1 may be encoded within a first QR code (QR1) within TEE 201 (element 205).

In element 206 a PAVP channel may be opened in order to securely display QR1 in an out-of-band (OOB) manner. Hardware-based (or out-of-band) management is different from software-based (or in-band) management and software management agents. Hardware-based management works at a different level than software applications and uses a communication channel (through the TCP/IP stack) that is different from software-based communication (which is through the software stack in the operating system (OS)). Hardware-based management does not depend on the presence of an OS or locally installed management agent. In element 207 QR1 is delivered via TEE channel 201 so it may be displayed in element 208. In an embodiment, this display is on a screen of a mobile computing node but in other embodiments the display may be holographic in nature or otherwise be presented in a third dimension (to accommodate 3D symbology).

In element 209 node 203 may enter into a TEE to enable a trusted scanning channel. In element 210 a PAVP channel to a camera is enabled. After acquisition of QR1 by node 203, node 203 may provide an ACK message to node 200. The ACK message may be encoded in an additional QR message. The ACK message may indicate to node 200 that node 203 has successfully received QR1. The ACK message is not depicted in FIG. 2.

In element 211 the delivered QR1 may be advanced into TEE 202 where it can be decoded (element 212). In an embodiment node 203 may verify or authenticate the content of QR1 (element 213). For example, TEE 202 may examine a digital signature placed on content of QR1 by node 200/TEE 201. The digital signature may correspond to a private key of node 200 to which node 203 has a corresponding public key. The public key may correspond to many private keys that collectively form a group signature scheme (e.g., Intel® Enhanced Privacy ID (EPID)), which provides for a Direct Anonymous Attestation (DAA) scheme. Thus, a node having the public key can attest that a signature was signed by a member of the group holding a private key but the exact identity of the member will be unknown. The signature may include a hash of the code used to generate the content of QR1. If the verification/authorization is unsuccessful the process may terminate. Otherwise, the process may proceed to element 214. The signature and public key may be vetted against a registry of revoked keys accessible via a communications network such as the internet.

In element 214 node 203/TEE 202 generates Sigma content (S2). This content may include g^{y}, based on the value y, of a typical Diffie-Hellman/Sigma process. S2 may be encoded within a second QR code (QR2) within TEE 202. S2 may include additional content beyond or instead of g^{y}. For example, S2 may include node 203's identity “B” (e.g., Intel® EPID), and a message authentication code (MAC) (a short piece of information used to authenticate a message and to provide integrity and authenticity assurances on the message). The MAC may be generated by a MAC algorithm (e.g., keyed (cryptographic) hash function) that accepts as input a secret key “K” (e.g., K may be based on g^{xy}, which is derived from (g^{x})^{y} or (g^{y})^{x} so K is therefore based on values x and y, albeit indirectly) and an arbitrary-length message, such as node 203's identity B, to be authenticated, and outputs a MAC (sometimes known as a tag) such as MAC_{K}(B). The MAC value protects both a message's data integrity as well as its authenticity, by allowing verifiers (who also possess the secret key K) to detect any changes to the message content. The S2 content may further include a signed value based on key K, which as noted above is “based on” (indirectly) x and y (i.e., g^{xy}, which is derived from (g^{x})^{y} or (g^{y}))^{x}). There are many variations of Sigma protocols and the specific contents of S2 in this embodiment are for illustrative purposes and are not limiting on all embodiments.

In element 215 a PAVP channel may be opened in order to securely display QR2 in an OOB manner. In element 216 QR2 is delivered via TEE channel 202 so it may be displayed in element 219. In element 218 node 200 may enter into TEE 201 to enable a trusted scanning channel. In element 217 a PAVP channel to a camera is enabled. After acquisition of QR2 by node 200, node 200 may provide an ACK message to node 203. The ACK message may be encoded in an additional QR message. The ACK message may indicate to node 203 that node 200 has successfully received QR2.

In element 220 the delivered QR2 may be advanced into TEE 201 where it can be decoded (element 221). In an embodiment node 201 may verify or authenticate the content of QR2 (element 222) in a manner similar to element 213 addressed above. If the verification/authorization is unsuccessful the process may terminate. Otherwise, the process may proceed to element 223.

In element 223 node 200/TEE 201 generates Sigma content (S3). S3 may be encoded within a third QR code (QR3) within TEE 201. S3 content may include node 200's identity “A”, and a MAC based on secret key “K” and node 200's identity A MAC_{K}(A) (and therefore S3 is “based” on A as well as MAC_{K}(A)). The S3 content may further include a signed value based on based on key K.

In element 224 a PAVP channel may be opened in order to securely display QR3 in an OOB manner. QR3 may be delivered via TEE channel 201 so it may be displayed in element 225. In element 226 node 203 may enter into TEE 202 with a trusted scanning channel. A PAVP channel to a camera is enabled. After acquisition of QR3 by node 203, node 203 may provide an ACK message to node 200. The ACK message may be encoded in an additional QR message. The ACK message may indicate to node 200 that node 203 has successfully received QR3.

In element 226 the delivered QR3 may be advanced into TEE 202 where it can be decoded (element 227). In an embodiment node 203 may verify or authenticate the content of QR3 (element 228) in a manner similar to element 213 addressed above. If the verification/authorization is unsuccessful the process may terminate. Otherwise, the process may proceed to element 229, 230 where messages may be exchanged between nodes 201, 203 based on the session key K or keys derived therefrom. The derivation need not be strictly interpreted. For example, the session key K may be used for Bob to share his public key (element 129) with Alice and vice versa (element 130).

In an embodiment (element 231) subsequent messages may be exchanged between nodes 200, 203 following QR coding/encoding described above. For example, email content may be encrypted within a QR code (encrypted with one node's private key) and then be transferred to another node that decrypts the QR code using a public key corresponding to the other node's private key. The QR code may be transferred via display by one node and camera capture by a second node (as addressed in FIG. 1). However, the QR code may instead be transferred via a network (e.g., email, internet, local area network (LAN), Bluetooth®) and then “scanned” or otherwise interpreted on another node (that is located remotely from the sender node).

However, in elements 229, 230 where messages may be exchanged between nodes 201, 203 based on the session key K (i.e., encrypted with key K or key(s) derived therefrom), those messages may be sent over any medium (e.g., chat, SMS text, email, and the like) using encryption based on the keys developed during earlier key exchange steps (FIG. 2). In such an embodiment QR codes are used for the initial key exchange but then subsequent communications (that may be encrypted based on the keys from the initial key exchange or keys derived therefrom) may be sent without use of QR codes.

While FIG. 2 addresses how a QR code may be transferred via display by one node and camera capture by a second node, the process of FIG. 2 may also be implemented in this alternative fashion (e.g., using internet communications such as email).

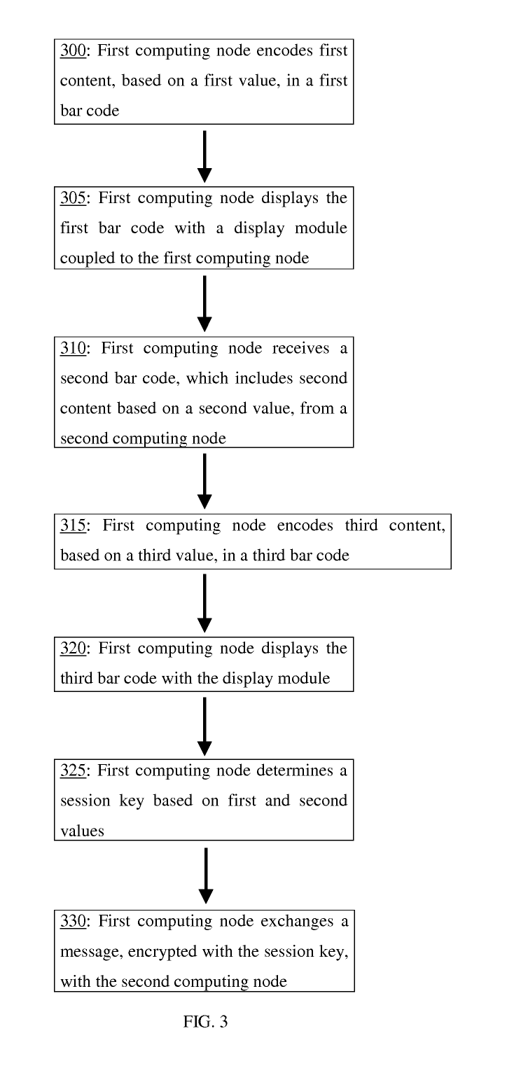

FIG. 3 includes a process for computing nodes to establish a secure digital relationship using symbology in an embodiment of the invention.

In block 300 a first computing node encodes first content, based on a first value, in a first bar code. The bar code may include 1, 2, or 3 dimensional bar codes. An example of a 2D bar code is a QR code.

In block 305 the first computing node displays the first bar code with a display module coupled to the first computing node. This module may provide for displaying the bar code on a display (e.g., on a screen of a smartphone or lens of networked spectacles) or via some other means (e.g., holographic means). In an embodiment the first computing node displays the first bar code via an out-of-band (OOB) input/output (I/O) channel

A module as used herein refers to any hardware, software, firmware, or a combination thereof. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices. However, in another embodiment, logic also includes software or code integrated with hardware, such as firmware or micro-code. Thus, the display module may display the bar code via various means.

In block 310 the first computing node receives a second bar code, which includes second content based on a second value, from a second computing node. In an embodiment the first content includes a first public key (e.g., g^{x}) (based on a value such as x) of the first computing node and the second content includes a second public key (e.g., g^{y}) (based on a value such as y) of the second computing node. In an embodiment the second bar code includes a MAC based on the first and second values (such as a MAC algorithm that uses key K based on x and y (g^{xy})) and an identifier for the second computing node (e.g., “B”). The first computing node may then authenticate the MAC based on the first and second values (e.g., using a MAC algorithm that uses key K). In an embodiment the first computing node scans the second bar code via an out-of-band (OOB) input/output (I/O) channel.

In block 315 the first computing node encodes third content based on a third value in a third bar code and in block 320 the first computing node displays the third bar code with the display module. In an embodiment the third bar code includes an additional MAC based on the first and second values and an identifier for the first computing node

In block 325 the first computing node determines a session key (e.g., K) based on first and second values (e.g., K=g^{xy}). In an embodiment the first computing node determines the session key via a Sigma protocol. In block 330 the first computing node exchanges a message (e.g., the message may include a public key), encrypted with the session key, with the second computing node.

In an embodiment the first computing node digitally signs information included in the first bar code and authenticates a signature, corresponding to the second computing node, on information included in the second bar code. In an embodiment the signature is a signature based, directly or indirectly, on the first and second values. In an embodiment the first computing node signs the information included in the first bar code based on a private key included in a group signature scheme.

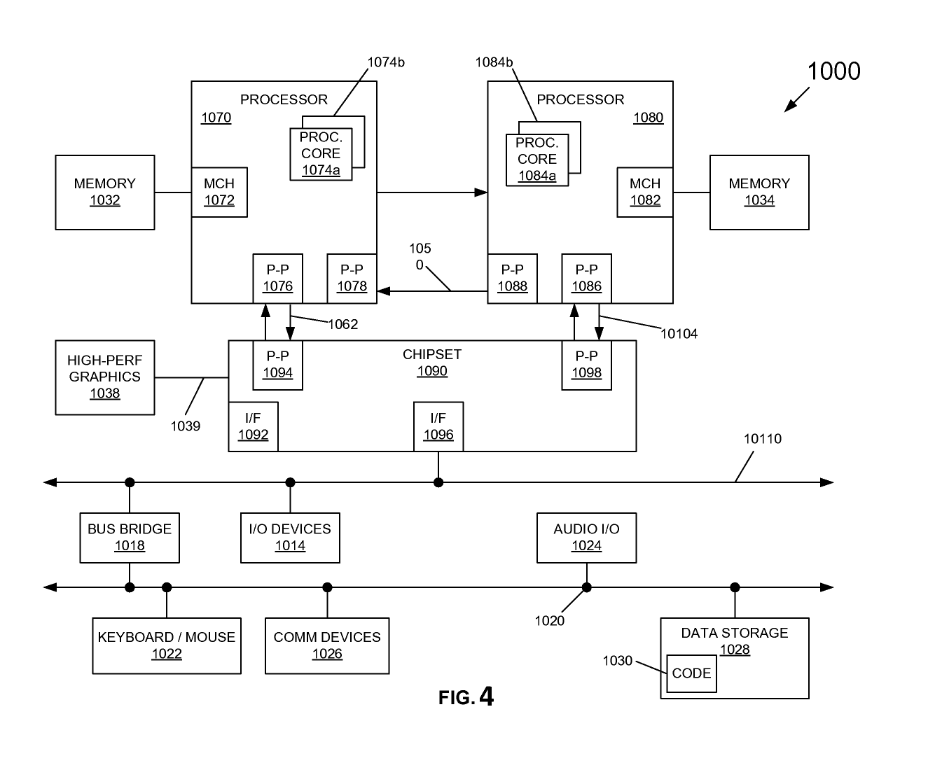

Elements discussed herein (e.g., node 200) may utilize a system such as the system of FIG. 4, discussed below. In fact, embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as (a) a computer program product that may include one or more machine readable media having stored thereon instructions that may be used to program a processing system or other electronic device to perform the methods or (b) at least one storage medium having instructions stored thereon for causing a system to perform the methods. The term “machine readable medium” or “storage medium” used herein shall include any medium that is capable of storing or encoding a sequence of instructions (transitory media, including signals, or non-transitory media) for execution by the machine and that cause the machine to perform any one of the methods described herein. The term “machine readable medium” or “storage medium” shall accordingly include, but not be limited to, memories such as solid-state memories, optical and magnetic disks, read-only memory (ROM), programmable ROM (PROM), erasable PROM (EPROM), electrically EPROM (EEPROM), a disk drive, a floppy disk, a compact disk ROM (CD-ROM), a digital versatile disk (DVD), flash memory, a magneto-optical disk, as well as more exotic mediums such as machine-accessible biological state preserving or signal preserving storage. A medium may include any mechanism for storing, transmitting, or receiving information in a form readable by a machine, and the medium may include a medium through which the program code may pass, such as antennas, optical fibers, communications interfaces, etc. Program code may be transmitted in the form of packets, serial data, parallel data, etc., and may be used in a compressed or encrypted format. Furthermore, it is common in the art to speak of software, in one form or another (e.g., program, procedure, process, application, module, logic, and so on) as taking an action or causing a result. Such expressions are merely a shorthand way of stating that the execution of the software by a processing system causes the processor to perform an action or produce a result.

Referring now to FIG. 4, shown is a block diagram of a system embodiment 1000 in accordance with an embodiment of the present invention. System 1000 may be included in, for example, a mobile computing node such as a cellular phone, smartphone, tablet, Ultrabook®, notebook, laptop, personal digital assistant, and mobile processor based platform.

Shown is a multiprocessor system 1000 that includes a first processing element 1070 and a second processing element 1080. While two processing elements 1070 and 1080 are shown, it is to be understood that an embodiment of system 1000 may also include only one such processing element. System 1000 is illustrated as a point-to-point interconnect system, wherein the first processing element 1070 and second processing element 1080 are coupled via a point-to-point interconnect 1050. It should be understood that any or all of the interconnects illustrated may be implemented as a multi-drop bus rather than point-to-point interconnect. As shown, each of processing elements 1070 and 1080 may be multicore processors, including first and second processor cores (i.e., processor cores 1074a and 1074b and processor cores 1084a and 1084b). Such cores 1074, 1074b, 1084a, 1084b may be configured to execute instruction code in a manner similar to methods discussed herein.

Each processing element 1070, 1080 may include at least one shared cache. The shared cache may store data (e.g., instructions) that are utilized by one or more components of the processor, such as the cores 1074a, 1074b and 1084a, 1084b, respectively. For example, the shared cache may locally cache data stored in a memory 1032, 1034 for faster access by components of the processor. In one or more embodiments, the shared cache may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the present invention is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, microarchitectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

First processing element 1070 may further include memory controller logic (MC) 1072 and point-to-point (P-P) interfaces 1076 and 1078. Similarly, second processing element 1080 may include a MC 1082 and P-P interfaces 1086 and 1088. MC's 1072 and 1082 couple the processors to respective memories, namely a memory 1032 and a memory 1034, which may be portions of main memory locally attached to the respective processors. While MC logic 1072 and 1082 is illustrated as integrated into the processing elements 1070, 1080, for alternative embodiments the MC logic may be discreet logic outside the processing elements 1070, 1080 rather than integrated therein.

First processing element 1070 and second processing element 1080 may be coupled to an I/O subsystem 1090 via P-P interfaces 1076, 1086 via P-P interconnects 1062, 10104, respectively. As shown, I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, a bus may be used to couple graphics engine 1038 to I/O subsystem 1090. Alternately, a point-to-point interconnect 1039 may couple these components.

In turn, I/O subsystem 1090 may be coupled to a first bus 10110 via an interface 1096. In one embodiment, first bus 10110 may be a Peripheral Component Interconnect (PCI) bus, or a bus such as a PCI Express bus or another third generation I/O interconnect bus, although the scope of the present invention is not so limited.

As shown, various I/O devices 1014, 1024 may be coupled to first bus 10110, along with a bus bridge 1018 which may couple first bus 10110 to a second bus 1020. In one embodiment, second bus 1020 may be a low pin count (LPC) bus. Various devices may be coupled to second bus 1020 including, for example, a keyboard/mouse 1022, communication device(s) 1026 (which may in turn be in communication with a computer network), and a data storage unit 1028 such as a disk drive or other mass storage device which may include code 1030, in one embodiment. The code 1030 may include instructions for performing embodiments of one or more of the methods described above. Further, an audio I/O 1024 may be coupled to second bus 1020.

Note that other embodiments are contemplated. For example, instead of the point-to-point architecture shown, a system may implement a multi-drop bus or another such communication topology. Also, the elements of FIG. 4 may alternatively be partitioned using more or fewer integrated chips than shown in the FIG. 4.

Example 1a includes at least one storage medium having instructions stored thereon for causing: a first computing node to (a) encode first content, which is based on a first value, in a first bar code, (b) display the first bar code with a display module coupled to the first computing node; (c) receive a second bar code, which includes second content, which is based on a second value, from a second computing node; (d) encode third content, which is based on a third value, in a third bar code, (e) display the third bar code with the display module; (f) determine a session key based on the first and second values; and (g) exchange a message, encrypted with the session key, with the second computing node.

In example 2a the subject matter of Example 1a can optionally include wherein the first, second, and third bar codes include at least one of a 2 dimensional (2D) bar code, a 3D bar code, and a quick response (QR) code; wherein the display module includes at least one of a 2D display and a 3D projection system.

In example 3a the subject matter of Examples 1a-2a can optionally include wherein the first content includes a first public key corresponding to the first computing node and the second content includes a second public key corresponding to the second computing node.

In example 4a the subject matter of Examples 1a-3a can optionally include wherein the second bar code includes a message authentication code (MAC) based on the first and second values and an identifier for the second computing node, the at least one medium comprising instructions to cause the first computing node to authenticate the MAC based on the first and second values.

In example 5a the subject matter of Examples 1a-4a can optionally include wherein the third bar code includes an additional MAC based on the first and second values and an identifier for the first computing node.

In example 6a the subject matter of Examples 1a-5a can optionally include instructions to cause the first computing node to display the first bar code via an out-of-band (OOB) input/output (I/O) channel.

In example 7a the subject matter of Examples 1a-6a can optionally include instructions to cause the first computing node to digitally sign information included in at least one of the first and third bar codes and authenticate a signature, corresponding to the second computing node, on information included in the second bar code.

In example 8a the subject matter of Examples 1a-7a can optionally include wherein the signature is a signature on the first and second content.

In example 9a the subject matter of Examples 1a-8a can optionally include instructions to cause the first computing node to sign the information included in the first bar code based on a private key included in a group signature scheme.

In example 10a the subject matter of Examples 1a-9a can optionally include wherein the instructions to cause the first computing node to receive the second bar code include instructions to cause the first computing node to scan the second bar code via an out-of-band (OOB) input/output (I/O) channel.

In example 11a the subject matter of Examples 1a-10a can optionally include instructions to cause the first computing node to determine the session key via a Sigma protocol.

Example 12a includes an apparatus comprising: a display module; at least one memory coupled to the display module; at least one processor, coupled to the at least one memory, to perform operations comprising: (a) encoding first content based on a first value in a first bar code, (b) displaying the first bar code with the display module; (c) receiving a second bar code, which includes second content based on a second value, from a second computing node; (d) encoding third content based on a third value in a third bar code, (e) displaying the third bar code with the display module; (0 determining an encryption key based on the first and second values; and (g) exchanging a message, encrypted based on the encryption key, with the second computing node.

For example, the TEE (e.g., 201) may attest (e.g., via a signature) to the configuration state of the TEE to a remote party (e.g., node 202). This state may concern the trusted path connection to a QR scanning device (camera) and a display device (e.g., PAVP). Attestation may also claim trustworthy presentation of context information such as 3D printed objects containing 3D bar codes (in addition to or instead of 2D bar codes) that describe the physical environment (e.g., in a coffee shop, outdoors, and the like) in which the user holding the smart device is present. This contextual information can be shared with the remote party where they can also observe and scan the same bar codes in the surrounding area to establish the physical context. These bar codes may include content that is also included in any of S1, S2, S3 in some embodiments. These attributes are a basis and setting for relating social trust to the keys that are also exchanged via Sigma and QR codes.

In example 13a the subject matter of Example 12 can optionally include wherein (a) the first, second, and third bar codes include at least one of a 2 dimensional (2D) bar code, a 3D bar code, and a quick response (QR) code; (b) the display module includes at least one of a 2D display and a 3D projection system; and (c) the message includes at least one of an email, short message service text, chat, audio, and video.

In example 14a the subject matter of Examples 12a-13a can optionally include wherein the first content includes a first public key of the first computing node and the second content includes a second public key of the second computing node.

In example 15a the subject matter of Examples 12a-14a can optionally include wherein the second bar code includes a message authentication code (MAC) based on the first and second values and an identifier for the second computing node, the operations comprising authenticating the MAC based on the first and second values.

In example 16a the subject matter of Examples 12a-15a can optionally include wherein the third bar code includes an additional MAC based on the first and second values and an identifier for the first computing node.

In example 17a the subject matter of Examples 12a-16a can optionally include wherein the operations comprise displaying the first bar code via an out-of-band (OOB) input/output (I/O) channel.

In example 18a the subject matter of Examples 12a-17a can optionally include wherein the operations comprise digitally signing information included in at least one of the first and third bar codes and authenticating a signature, corresponding to the second computing node, on information included in the second bar code.

In example 19a the subject matter of Examples 12a-18a can optionally include wherein the signature is a signature on the first and second content.

In example 20a the subject matter of Examples 12a-19a can optionally include wherein the operations comprise signing the information included in the first bar code based on a private key included in a group signature scheme.

In example 21a the subject matter of Examples 12a-20a can optionally include wherein the operations comprise scanning the second bar code via an out-of-band (OOB) input/output (I/O) channel.

In example 22a the subject matter of Examples 12a-21a can optionally include wherein the operations comprise determining the encryption key via a Sigma protocol.

Example 23a includes an apparatus comprising: a display module; at least one memory coupled to the display module; at least one processor, coupled to the at least one memory, to perform operations comprising: (a) encoding first content, based on a first value, in a first bar code, (b) displaying the first bar code with the display module; (c) receiving a second bar code, which includes second content, based on a second value, from a second computing node; (d) determining an encryption key based on the first and second values; and (e) exchanging a communication, encrypted based on the encryption key, with the second computing node. Such an apparatus may include, for example, node 203 described in FIG. 2. Such an apparatus may include, for example, node 203 described in FIG. 2 involved in a handshake that takes a number of steps that is equal or unequal (e.g., less) to three. In an embodiment the second content may include S1 or S3 as described above.

In example 24a the subject matter of Example 23a can optionally include wherein the communication includes at least one of an email, short message service text, chat, audio, and video.

In example 25a the subject matter of Examples 23a-24a can optionally include wherein the operations comprise digitally signing information included in the first bar code and authenticating a signature, corresponding to the second computing node, on information included in the second bar code; wherein the signature is a signature on the first and second values.

Example 1b includes an embodiment includes a method executed by at least one processor comprising: a first computing node (a) encoding first content, based on a first value, in a first bar code, (b) displaying the first bar code with a display module coupled to the first computing node; (c) receiving a second bar code, which includes second content, based on a second value, from a second computing node; (d) encoding third content, based on a third value, in a third bar code, (e) displaying the third bar code with the display module; (f) determining a session key based on the first and second values; and (g) exchanging a message, encrypted with the session key, with the second computing node.

In example 2b the subject matter of Example 1b can optionally include wherein the first, second, and third bar codes include at least one of a 2 dimensional (2D) bar code, a 3D bar code, and a quick response (QR) code; wherein the display module includes at least one of a 2D display and a 3D projection system.

In example 3b the subject matter of Examples 1b-2b can optionally include wherein the first content includes a first public key corresponding to the first computing node and the second content includes a second public key corresponding to the second computing node.

In example 4b the subject matter of Examples 1b-3b can optionally include wherein the second bar code includes a message authentication code (MAC) based on the first and second values and an identifier for the second computing node, the method comprising authenticating the MAC based on the first and second values.

In example 5b the subject matter of Examples 1b-4b can optionally include wherein the third bar code includes an additional MAC based on the first and second values and an identifier for the first computing node.

In example 6b the subject matter of Examples 1b-5b can optionally include displaying the first bar code via an out-of-band (OOB) input/output (I/O) channel.

In example 7b the subject matter of Examples 1b-6b can optionally include digitally signing information included in the first bar code and authenticating a signature, corresponding to the second computing node, on information included in the second bar code.

In example 8b the subject matter of Examples 1b-7b can optionally include wherein the signature is a signature on the first and second content.

In example 9b the subject matter of Examples 1b-8b can optionally include signing the information included in the first bar code based on a private key included in a group signature scheme.

In example 10b the subject matter of Examples 1b-9b can optionally include scanning the second bar code via an out-of-band (OOB) input/output (I/O) channel.

In example 11b the subject matter of Examples 1b-10b can optionally include determining the session key via a Sigma protocol.

Example 12b includes at least one machine readable medium comprising a plurality of instructions that in response to being executed on a computing device, cause the computing device to carry out a method according to any one of examples 1b to 11b.

Example 13b includes an apparatus comprising means for performing any one of examples 1b to 11b.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. At least one storage medium having instructions stored thereon for causing:
a first computing node to (a) encode first content, which is based on a first value, in a first bar code, (b) display the first bar code with a display module coupled to the first computing node; (c) receive a second bar code, which includes second content based on a second value, from a second computing node; (d) encode third content, which is based on a third value, in a third bar code, (e) display the third bar code with the display module; (f) determine a session key based on the first and second values; and (g) exchange a message, encrypted with the session key, with the second computing node.

2. The at least one medium of claim 1,
wherein the first, second, and third bar codes include at least one of a 2 dimensional (2D) bar code, a 3D bar code, and a quick response (QR) code;
wherein the display module includes at least one of a 2D display and a 3D projection system.

3. The at least one medium of claim 1, wherein the first content includes a first public key corresponding to the first computing node and the second content includes a second public key corresponding to the second computing node.

4. The at least one medium of claim 1, wherein the second bar code includes a message authentication code (MAC) based on the first and second values and an identifier for the second computing node, the at least one medium comprising instructions to cause the first computing node to authenticate the MAC based on the first and second values.

5. The at least one medium of claim 4, wherein the third bar code includes an additional MAC based on the first and second values and an identifier for the first computing node.

6. The at least one medium of claim 1 comprising instructions to cause the first computing node to display the first bar code via an out-of-band (OOB) input/output (I/O) channel.

7. The at least one medium of claim 1 comprising instructions to cause the first computing node to digitally sign information included in at least one of the first and third bar codes and authenticate a signature, corresponding to the second computing node, on information included in the second bar code.

8. The at least one medium of claim 7, wherein the signature is a signature on the first and second content.

9. The at least one medium of claim 7 comprising instructions to cause the first computing node to sign the information included in the first bar code based on a private key included in a group signature scheme.

10. The at least one medium of claim 1, wherein the instructions to cause the first computing node to receive the second bar code include instructions to cause the first computing node to scan the second bar code via an out-of-band (OOB) input/output (I/O) channel.

11. The at least one medium of claim 1 comprising instructions to cause the first computing node to determine the session key via a Sigma protocol.

12. An apparatus comprising:
a display module;
at least one memory coupled to the display module;
at least one processor, coupled to the at least one memory, to perform operations comprising: (a) encoding first content, which is based on a first value, in a first bar code, (b) displaying the first bar code with the display module; (c) receiving a second bar code, which includes second content based on a second value, from a second computing node; (d) encoding third content, which is based on a third value, in a third bar code, (e) displaying the third bar code with the display module; (f) determining an encryption key based on the first and second values; and (g) exchanging a message, encrypted based on the encryption key, with the second computing node.

13. The apparatus of claim 12, wherein (a) the first, second, and third bar codes include at least one of a 2 dimensional (2D) bar code, a 3D bar code, and a quick response (QR) code; (b) the display module includes at least one of a 2D display and a 3D projection system; and (c) the message includes at least one of an email, short message service text, chat, audio, and video.

14. The apparatus of claim 12, wherein the first content includes a first public key of the first computing node and the second content includes a second public key of the second computing node.

15. The apparatus of claim 12, wherein the second bar code includes a message authentication code (MAC) based on the first and second values and an identifier for the second computing node, the operations comprising authenticating the MAC based on the first and second values.

16. The apparatus of claim 15, wherein the third bar code includes an additional MAC based on the first and second values and an identifier for the first computing node.

17. The apparatus of claim 12, wherein the operations comprise displaying the first bar code via an out-of-band (OOB) input/output (I/O) channel.

18. The apparatus of claim 12, wherein the operations comprise digitally signing information included in at least one of the first and third bar codes and authenticating a signature, corresponding to the second computing node, on information included in the second bar code.

19. The apparatus of claim 18, wherein the signature is a signature on the first and second content.

20. The apparatus of claim 19, wherein the operations comprise signing the information included in the first bar code based on a private key included in a group signature scheme.

21. The apparatus of claim 12, wherein the operations comprise scanning the second bar code via an out-of-band (OOB) input/output (I/O) channel.

22. The apparatus of claim 12, wherein the operations comprise determining the encryption key via a Sigma protocol.

23. An apparatus comprising:
a display module;
at least one memory coupled to the display module;
at least one processor, coupled to the at least one memory, to perform operations comprising: (a) encoding first content, which is based on a first value, in a first bar code, (b) displaying the first bar code with the display module; (c) receiving a second bar code, which includes second content based on a second value, from a second computing node; (d) determining an encryption key based on the first and second values; and (e) exchanging a communication, encrypted based on the encryption key, with the second computing node.

24. The apparatus of claim 23, wherein the communication includes at least one of an email, short message service text, chat, audio, and video.

25. The apparatus of claim 23:
wherein the operations comprise digitally signing information included in the first bar code and authenticating a signature, corresponding to the second computing node, on information included in the second bar code;
wherein the signature is a signature on the first and second content.
